(19) United States
(12) Patent Application Publication
(10) Pub. No.: US 2002/0075566 A1
(43) Pub. Date: Jun. 20, 2002

(54) 3D or multiview light emitting display

(76) Inventors: Lee W. Tutt, Webster, NY (US); Mitchell S. Burberry, Webster, NY (US); Myron W. Culver, Rochester, NY (US); Ching W. Tang, Rochester, NY (US)

Correspondence Address: Thomas H. Close, Patent Legal Staff, Eastman Kodak Company, 343 State Street, Rochester, NY, 14650-2201, US

(21) Appl. No.: 09/739,859

(22) Filed: Dec. 18, 2000

(51) Int. Cl. G02B 27/10

(52) U.S. Cl. 359/619; 359/621; 359/622; 359/623

(57) ABSTRACT

A system for the display of digital or analog images with a beam-forming apparatus comprised of lenticular lens elements secured to or integrated with, or associated with individual pixel lines or sub-pixel elements in a line in the display. A lenticular array material can either be used as the substrate of the solid-state display device or affixed to the display device. A light emitting display device includes:

a) a transparent substrate;

b) an array of parallel cylindrical lenses located on one side of the substrate having a focal point coinciding with the opposite side of the substrate;

c) an array of individually addressable light emitting elements located on the other side of the substrate, the light emitting elements forming lines of a bundle of elements parallel to the cylindrical axes of the cylindrical lenses and being spaced such that there are a plurality of lines of light emitting elements corresponding to each cylindrical lens placed so that each bundle of elements in a line is associated substantially at the same pitch and aligned with each lenticular element in the display device; and a control for a displaying image elements on each line of pixels of the imaging device.

### FIELD OF THE INVENTION

The present invention relates to display devices with integrated image directing lenticular arrays. More particularly, the present invention relates to the use of solid state emissive display devices with small cylindrical lenses integrated into the display device substrate and associated with each pixel, sub-pixel or line of elements.

### BACKGROUND OF THE INVENTION

Digital imaging devices are widely known and used in electronic equipment. Solid-state imaging devices, those which are constructed on a substrate which may contain integrated drive circuitry, are very useful for portable imaging applications in which a light, rugged, high-quality display is needed. Such devices often rely on liquid crystal displays or light emitting diodes. In particular, organic light emitting diodes (OLEDs) provide a very thin, high-quality, and low-power technology for color image display with Lambertian emission characteristics providing a wide viewing angle. The OLED technology can be built upon a glass or plastic substrates as well as traditional silicon wafers.

Such displays, in general, are capable of reproducing images by writing specific information to a plurality of pixels on a surface. These pixels are generally organized as a rectangular array and are addressed via control lines connected to the display device. Each pixel is individually addressable and specific data values, representing an amount of light to be produced, can be written to them; each data value then being expressed as an element in the displayed image. For color displays, each pixel is generally composed of sub-pixel elements in each of several, usually three, primary colors—typically red, green, and blue. Since the sub-pixel elements are so small, a human observer will see the additive combination of the primary colors enabling the display of many different colors. Each of these sub-pixels is individually addressable by the control and data lines of the display device.

Optical technology has now progressed to the point that very small optical elements can be created. These elements can be fabricated in a variety of ways and can be combined into an array of small elements covering a surface. Each lens element affects the light passing through according to that element's surface profile and its refractive index. The lens element is referred to as a lens-let, micro-lens-let, or micro-lens. This technique of optical design differs from the traditional in that different portions of a beam can be made to pass through different optical elements, enabling a variety of effects. The construction of the lens-lets on a surface also enables the implementation of optical effects using smaller optical elements because each lens-let is very small and the surface on which they are made can be very thin and light-weight. It is also the case that construction techniques for lens-let arrays has progressed to the point that such arrays are well understood and manufacturable (for example U.S. Pat. No. 5,867,321). Hence, thin, robust, imaging systems with a wide variety of properties can be created using this technology.

Another micro-lens technology involves cylindrical lens-let arrays usually referred to as lenticular arrays. A lenticular image such as a photographic print, transparency media or displayed on a CRT, is termed a lenticular image and comprises “bundles” of image elements comprising lines interleaved from a plurality of images of a scene taken from different points of view for depth or 3D images or from a plurality of images depicting motion. Each bundle contains a line of image elements from each of the original images in sequence, and all image bundles are usually equal in width. When image bundles of equal width abut one another, the width of a bundle is its “pitch.” When image bundles of equal width are spaced apart equally, the pitch is the sum of the bundle width and width of the space between bundles. The image lines are created typically by scanning lines from a set of original images and recomposing them for digital display. A lenticular overlay, or faceplate, comprising a plurality of oriented lenticules having substantially the same pitch as the image element bundles in the lenticular display, when placed over the media and in proper alignment with the image lines, projects the plurality of images at different viewing angles corresponding to the viewing angles of the original scene. This provides an image, which evokes a sense of depth (i.e. a third dimension), or motion to a human viewer.

U.S. Pat. No. 4,959,641 discloses a stereoscopic display device in which a plurality of independently controllable and discrete light sources are provided in a fixed relation to a lenticular screen. The light sources may comprise visible light emitting diodes. Problems with this display device include the difficulty of making the diodes in the array small enough to produce a small high resolution display, and the difficulty of registering the light emitting diodes with the lenticular screen. There is a need therefore for an improved method of making a display device that avoids these problems.

### SUMMARY OF THE INVENTION

The need is met according to the present invention by an integrated solid-state display device with a transparent substrate incorporating lenticular arrays associated with each image element bundle. The device controlling the display can energize pixels using conventional means to operate the device according to the application needs.

According to a feature of the invention there is provided a method of making a display device of the type that includes a transparent substrate, an array of parallel cylindrical lenses located on one side of the substrate and an array of individually addressable light emitting elements located on the other side of the substrate, comprising the steps of:

a) providing a transparent substrate having an array of parallel cylindrical lenses on one side;

b) forming an array of electrodes on the opposite side of the substrate; and

c) depositing organic light emitting diode materials onto the array of electrodes.

### ADVANTAGEOUS EFFECT OF THE INVENTION

The present invention has the advantage of providing a low-cost, small, and robust mechanism for projecting a plurality of images. The system can be readily applied to three-dimensional imaging formed from an image display device.

### BRIEF DESCRIPTION OF THE DRAWINGS

FIG. 1 is a cross section of a display device, in this case an OLED display, with a lenticular array attached to the viewable side of the display.

FIG. 2 is a display device with lenticular array, attached to a source of images, typically a computer system.

FIG. 3 is a display system with multiple images sent to respective multiple viewers.

FIG. 4 is a display system with a lenticular array forming a plurality of images arranged to give a viewer the illusion of an image in three dimensions.

### DETAILED DESCRIPTION OF THE INVENTION

According to the present invention, a display device of the type that includes a transparent substrate, an array of parallel cylindrical lenses located on one side of the substrate and an array of individually addressable light emitting elements located on the other side of the substrate, is made by providing an array of parallel cylindrical lenses on one side of the transparent substrate. An array of electrodes are formed on the opposite side of the substrate, and organic light emitting diode (OLED) materials are deposited onto the array of electrodes. The OLED materials are placed so that sets of lines of light emitting elements are aligned with each cylindrical lens element in the display device.

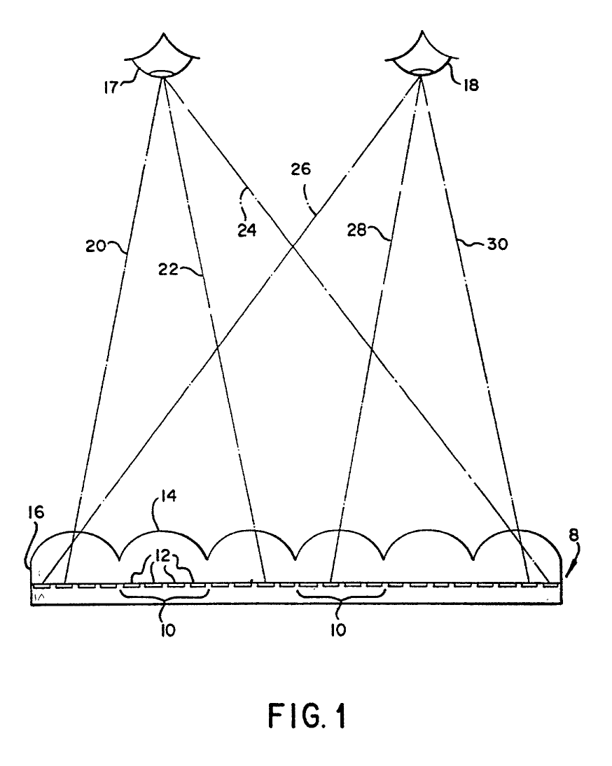

FIG. 1 illustrates a depth image display device system 8 according to the present invention. The display device is constructed as follows. First, a glass or plastic cylindrical lens array 14 is formed on one side of a glass substrate 16 (or other suitable transparent material). The other side of the substrate 16 is prepared appropriately for the deposition of materials needed to create an OLED display, which emits light through the substrate. The OLED display includes sets 10 of lines of light emitting elements 12 for each cylindrical lens element 14. When viewed, one image line 12 of each set 10 is seen by each eye 17 and 18 and the observed image lines (view slices) merge to create a complete scene. The scene observed by each eye 17 and 18 is different as a function of the viewing angle and this can be interpreted as depth by the observer, if the views from each angle are different perspectives of the same scene. However, it must be appreciated that for a single eyed version, horizontal motion of the eye will provide the same depth or look around effect. The eyes 17 and 18 see the image via rays, for example, rays 20-30 through the cylindrical lens elements 14 of the overlay 16 as a series of simultaneous image lines or view slices. Eye 17 sees image lines or view slices via rays 20-24 and combines the view slices into a composite, single first view while eye 18 sees image lines or view slices via rays 26-30 and combines the view slices into a composite, single second view. The different scenes provided by the first and second views provides the depth perspective.

The cylindrical lenses are constructed such that the focal point is on the plane of light emitting elements (i.e. the focal plane of the lens is the other surface of the substrate 16). Care must also be taken such that the light emitting element pitch is close to the pitch of the lenses but slightly larger. If the pitch of the light emitting elements is identical, the image could only be viewed infinitely far away. By increasing the pitch of the light emitting elements relative to the pitch of the lenses, the proper viewing distance can be moved closer to a distance appropriate to the application. FIG. 1 shows the placement of light emitting elements relative to the lens for a proper viewing distance.

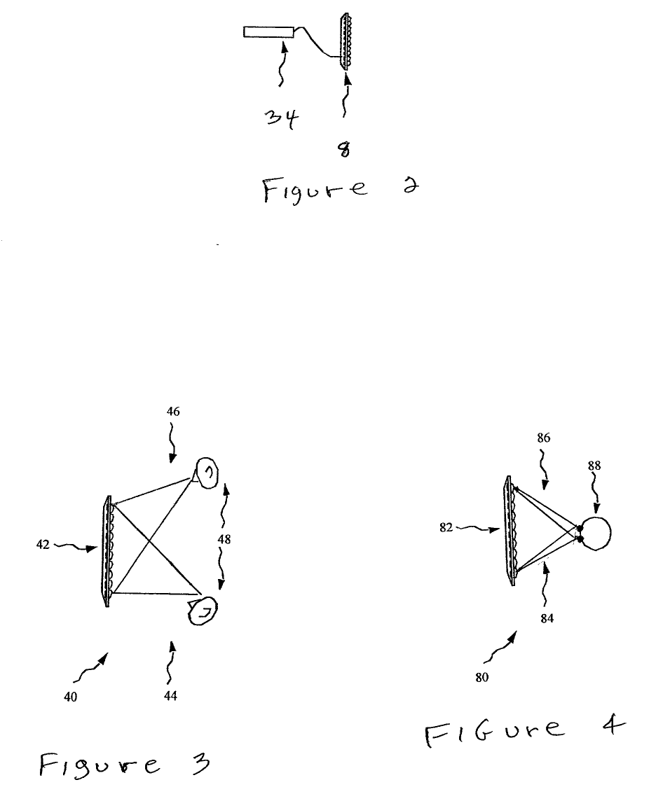

FIG. 2 illustrates an appropriate controlling system wherein the device 8 is connected to a source of image data and control electronics 34 and the system is ready for use.

Note that any materials necessary to the construction of the display device that are placed between the light-emitting elements and the transparent substrate must also be transparent. Such materials, such as contacts made of indium tin oxides, are well-known in the art.

Examples of various applications and methods of operation of the display system, are shown in FIGS. 3 and 4. FIG. 3 shows an OLED device 40 with a lenticular array 42 displaying image information. The lenticular array directs the light 44 from every other line of pixels in one direction and light from the remaining pixels in a separate direction 46, Separate viewers 48 can observe each beam of light. The controlling device can then display two separate images, one for each viewer, on the same display. Alternatively, each view can be directed to a different eye of the same view. When held at an appropriate distance from the observer, each beam can be made to intercept a different eye. If the controlling device again displays two views of the same scene on each side of the display, the viewer can experience a stereo-optic effect, the image is seen in three-dimensions.

FIG. 4 shows that the lenticular array 82 of device 80 directing beams 84 and 86 from the lenticules 81 of the display device 80 which converge on different eyes. When held at an appropriate distance from the observer, each beam 84 and 86 can be made to intercept a different eye. If the controlling device again displays two views of the same scene, thereby presenting a 3D image to viewer 88.

It is also possible to use substrate materials other than glass such as polymers, for example polycarbonate, polyethylene terephthalate glycol, etc. The only restriction is that the display device materials may be suitably deposited on the substrate. As long as deposition is possible on one side of the substrate material and the material is suitable for the manufacturing process, any substrate material capable of forming a lenticular array on the opposite side is possible.

This invention can also be practiced by carefully affixing a lenticular array to the substrate on the side opposite the light-emitting materials. The device must be aligned to the substrate so that each lenticule is associated with the particular bundle of pixels intended and so that no unnecessary interference will degrade the optical quality of the system.

Although the invention is described with reference to use of organic light emitting diode technology, any display technology which can be built upon a transparent substrate capable of forming lenticles so long as the light from the display can travel through the substrate and lenticles.

In a preferred embodiment, the invention is employed in an emissive display that includes Organic Light Emitting Diodes (OLEDs) which are composed of small molecule OLEDs as disclosed in but not limited to U.S. Pat. No. 4,769,292, issued Sep. 6, 1988 to Tang et al., entitled “Electroluminescent Device with Modified Thin Film Luminescent Zone” and U.S. Pat. No. 5,061,569, issued Oct. 29, 1991 to VanSlyke et al., entitled “Electroluminescent Device with Organic Electroluminescent Medium”. This technology provides a platform on which an integrated imaging platform with a transparent substrate can be constructed. Many combinations and variations of OLED materials can be used to fabricate such a device, such as polymeric materials and are included in this invention. Methods for deposition can include evaporation through a shadow mask or laser thermal deposition. The deposited silicon materials may be single-crystal in nature or be amorphous, polycrystalline, or continuous grain. These deposited materials and substrates are known in the prior art and this invention may be applied equally to any micro-circuit integrated on a suitable substrate.

A solid state display device with an integrated lenticular array provides a very low-cost, manufacturable, and robust way to combine optical elements with a high-quality display device. Because both the lenticules and the display devices are readily manufactured using standard processes and placed on opposite sides of the same surface, an extremely robust, thin, lightweight imaging device supporting a wide variety of optical effects can be made at low cost.

The invention has been described in detail with particular reference to certain preferred embodiments thereof, but it will be understood that variations and modifications can be effected within the spirit and scope of the invention.

### PARTS LIST

8 display device system

10 set

12 one image line

14 cylindrical lens array

16 glass substrate

17,18 eye

20-30 rays

34 image data and control electronics

40 OLED device

42 lenticular array

44 light

46 direction

48 viewers

80 device

82 lenticular array

84-86 directing beams

88 viewer

What is claimed is:

1. A method of making a display device of the type that includes a transparent substrate, an array of parallel cylindrical lenses located on one side of the substrate and an array of individually addressable light emitting elements located on the other side of the substrate, comprising the steps of:
a) providing a transparent substrate having an array of parallel cylindrical lenses on one side;
b) forming an array of electrodes on the opposite side of the substrate; and
c) depositing light emitting diode materials onto the array of electrodes.

2. The method claimed in claim 1, wherein the light emitting diode material is deposited as electron injection layer, a hole injecting layer, and a light emissive material.

3. The method claimed in claim 2, wherein the light emissive layer is deposited using laser thermal deposition.

4. The method claimed in claim 1, wherein the array of electrodes includes individual driver transistors for each light emitting element.

5. The method claimed in claim 1, wherein the light emitting elements are addressed by row and column address lines.

6. A light emitting display device comprising:
a) a transparent substrate;
b) an array of parallel cylindrical lenses located on one side of the substrate having a focal point coinciding with the opposite side of the substrate;
c) an array of individually addressable light emitting elements located on the other side of the substrate, the light emitting elements forming lines of a bundle of elements parallel to the cylindrical axes of the cylindrical lenses and being spaced such that there are a plurality of lines of light emitting elements corresponding to each cylindrical lens placed so that each bundle of elements in a line is associated substantially at the same pitch and aligned with each lenticular element in the display device; and
a control for a displaying image elements on each line of pixels of the imaging device.

7. The device of claim 6 wherein said substrate is glass.

8. The device of claim 6 wherein said substrate is plastic.

9. The device of claim 6 wherein a 3D image is displayed.

10. The device of claim 6 wherein to different images are displayed to two viewers simultaneously.

11. The device of claim 6 wherein said 3D image displayed represents a video image

12. An imaging device comprising:
a) a digital imaging display having lines of pixels formed on a first substrate;
b) an array of parallel lenticules formed on a second substrate and fixed to and aligned with the opposite side of the first substrate such that each lenticule is associated with each said line of pixels; and
c) a control for displaying image elements on each line of pixels of the imaging device.

13. The device of claim 12 wherein a 3D image is displayed.

14. The device of claim 12 wherein said digital imaging display includes OLED devices.

15. The method of claim 2 wherein the light emissive layer is deposited by evaporation through a shadow mask.
